(19) United States
(12) Patent Application Publication
(10) Pub. No.: US 2004/0154965 A1
(43) Pub. Date: Aug. 12, 2004

(54) Wet and dry weather water flows disinfection system

(76) Inventors: Marc M. Baum, Pasadena, CA (US); Weng Ki Ching, Pasadena, CA (US); Michael R. Hoffmann, South Pasadena, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/719,924

(22) Filed: Nov. 21, 2003

Related U.S. Application Data
(60) Provisional application No. 60/428,653, filed on Nov. 25, 2002.

(51) Int. Cl. B01D 17/12

(52) U.S. Cl. 210/85; 210/87; 210/96.1; 210/198.1; 210/143; 422/105; 210/109

(57) ABSTRACT

An automated system for upstream, chemical disinfection of wet and dry weather water flows. The system combines chemical disinfection with a sophisticated feed-back control model for efficient disinfection rates and optimized consumables usage without the generation of environmentally-damaging residues. The model is steered by inputs from an array of sensors measuring key physiochemical and biological parameters. The system is designed to optionally permit remote access via computer networks such as the Internet or telemetry.

### CROSS-REFERENCE TO RELATED APPLICATION(S)

This patent application claims priority based on U.S. provisional patent application No. 60/428,653, filed on Nov. 25, 2002, for the invention entitled “IN-LINE STORMWATER DISINFECTION SYSTEM.”

### BACKGROUND OF THE INVENTION

Storm-generated flows occur both randomly and intermittently. They are difficult to predict, and exhibit highly varying intensities over short periods of time in terms of hydraulic, pollutant, and microorganism quality. Urban stormwater and other wet weather flows as well as dry weather flows may carry significant quantities of debris and pollutants, including litter, oils, heavy metals, sediments, organic matter, and pathogenic microorganisms and are considered some of the major sources of diffuse pollution to the aqueous environment. A sewer, runoff channel or conduit can go from completely dry to a thousand times the steady-state flow conditions associated with sanitary (i.e., domestic) wastewater. The runoff flow rate, FR_{R} (m³-h⁻¹), entering the stormwater and runoff water management system is defined in Eq. (1) as:

FR_{R}=P×10×P_{R}×A (1)

where, P is the total rainfall (mm-h⁻¹), PR is the catchment runoff efficiency (0.1-1.0 typical), and A is the effective collection area (ha, 10⁴ m²). For a small catchment, P_{R} would be of the order of 0.1 ha and peak rainfall for a storm event would be in the 50 mm-h⁻¹ range, leading to peak FRR values of 50 m³-h⁻¹ for a highly efficient catchment. Larger systems could collect and channel water flow rates one order of magnitude greater.

The characteristics of stormwater and other wet weather water flows also vary according to the manner in which the flow is routed to the receiving water. Wet weather flow discharges to a receiving water body can originate from three principal source types: (1) Combined-sewer overflow (CSO), carrying a mixture of municipal-industrial wastewater and water discharged from combined sewers, or dry-weather flow discharged from combined sewers due to clogged interceptors, inadequate interceptor capacity, or malfunctioning CSO regulators; (2) Separate storm drainage systems (storm drain outflows include pipes, culverts, rivers, creeks and streams); and (3) Sanitary-sewer overflows (SSO) and bypasses resulting from stormwater and groundwater infiltration and/or inflow. In addition to stormwater and other wet weather water flows, there can be dry weather types of water flows such as flows from creeks, agricultural and food waste runoffs, and residential runoffs, just to name a few sources. Dry weather flows can also pass through combined-sewer overflow and separate storm drainage systems. Regardless of whether the water to be treated is characterized as wet weather or dry weather runoff water, it may still need treatment.

The stormwater and other wet weather water flows and dry weather water flows flowing into receiving waters also can be of mixed origin, such as discharges from both urban and non-urban land areas. The many variables that affect pollutant and microbial content and levels of water, and/or the receiving waters, make the adaptation of existing analytical and disinfection methods for the monitoring and treatment of these waters, respectively, highly challenging.

The presence of microorganisms of fecal origin in stormwater and other wet weather as well as dry weather water flows can be attributed to septic tank seepage, sewer leakage and overflow, and domestic animal feces. Human-enteric pathogens (e.g., Escherichia coli and streptococci) are of particular concern in terms of human health effects, but a wide rage of non-enteric pathogens (e.g., staphylococcus, Pseudomonas aeruginosa, Klebsiella, and adenoviruses) also contribute significantly towards water's disease-causing potential. The suitability of total coliform (TC), fecal coliform (FC), and fecal streptococcus indicators of human pathogens has been discussed in detail in the literature. The most widely used bacteriological criterion in the U.S. today is the maximum recommended 30-day average density of 200 FC organisms per 100 mL of sample. A variety of state-level standards also exist.

To date, the disinfection of stormwater and other runoffs has been achieved using a downstream approach, where the flows from multiple drainage systems are combined at a centralized plant. There, they are treated using a wide range of potential technologies including: ozone, ultraviolet (UV) irradiation, chemical disinfection using chlorine (Cl₂) and/or chlorine dioxide (ClO₂), and wetlands. While some of these systems have shown promise in reducing waterborne microbial pathogen levels, their widespread usage has been hampered severely by the high associated infrastructure and maintenance costs. In addition, each technology type has at least one other serious limitation. Ozone-based disinfection systems are large and power-intensive, require relatively long detention times, and can lead to toxic residues (e.g., bromate). Ultraviolet disinfection systems are power-intensive, require relatively long detention times, and experience low efficiencies at water turbidity levels typical of stormwater and other runoff waters. Chemical disinfection systems can lead to toxic and carcinogenic residues (e.g., volatile haloforms and chlorinated aromatics), and require the storage of highly toxic materials (e.g., Cl₂ cylinder gas). Wetlands attract birds and other fauna, which can significantly increase the levels of fecal microorganisms discharged to surface waters.

Upstream, in-line treatment of stormwater and other runoffs by means of storm-inlet devices can represent an efficient and economic means of removing debris (litter and sediments) as well as hydrocarbons from wet weather flow discharges. These units can be deployed over multiple locations, at strategic points where runoff water enters the sewer, and offer an attractive means of controlling associated pollution. Numerous inventions relating to storm-inlet devices for debris removal as well as debris and hydrocarbon removal have been disclosed in recent years and some have been commercialized. Related technologies for the removal of oxyanions (e.g., phosphate) and “undesirable ionic species” also have been disclosed.

The only commercially available upstream, in-line system for runoff water disinfection consists of a combination of two patented technologies (Ultra-Urban® Filter with Smart Sponge®, AbTech Industries, Inc., Scottsdale, Ariz. and AM500, BioShield Technologies, Inc., Norcross, Ga.): the hydrocarbon-adsorbing polymer sponge of the storm inlet device is impregnated with an organosilane biocide, which presumably remains surface-bound on the filter. The efficacy of this approach with respect to runoff water disinfection has not been reported to date, but is questionable due to the high required contact times (multiple hours) and mode of action (i.e., direct contact between the cell and the filter coating).

There accordingly remains a need for a wet and dry weather water disinfection system that is effective, economical, and environmentally safe.

### BRIEF DESCRIPTION OF THE INVENTION

The invention provides a wet and dry weather water disinfection system, comprising:

a disinfecting chemical dispenser;

a mixing chamber wherein a disinfection chemical from the disinfecting chemical dispenser is added to the water to be treated; and

a control unit that controls the addition of disinfection chemical to the water to be treated. The invention further provides an automated system for chemical disinfection of wet and dry weather water flows, comprising:

a disinfecting chemical dispenser;

a mixing chamber wherein a disinfection chemical from the disinfecting chemical dispenser is added to water to be treated and the water and the disinfecting chemical mix;

a sensor to measure the water's characteristics; and

a control unit that controls the injection of disinfection chemical to the water.

The invention provides an automated system for chemical disinfection of wet and dry weather water flows, comprising:

a disinfecting chemical dispenser;

a mixing chamber wherein a disinfection chemical from the disinfecting chemical dispenser is added to water and the water and the disinfecting chemical mix;

sensors to measure the water's characteristics comprising at least one sensor located upstream of the disinfecting chemical dispenser, at least one sensor in the mixing chamber, and at least one sensor downstream of the mixing chamber to measure the chemically treated water's characteristics; and

a control unit that controls the injection of disinfection chemical to the water, wherein the control unit incorporates a feed-back protocol that incorporates an array of physical, chemical and/or biological parameters for efficiently disinfecting the water.

### BRIEF DESCRIPTION OF THE DRAWINGS

FIG. 1 is a schematic drawing of an exemplary embodiment of an in-line configuration of the system of the invention.

FIG. 2 is a schematic drawing of an exemplary embodiment of a by-pass configuration of the system of the invention.

FIG. 3 is a schematic drawing of an exemplary catch basin on a street and an exemplary embodiment of the system of the invention.

FIG. 4 is a UV absorption spectrum of ClO₂ in aqueous solution.

FIG. 5 is a UV absorption spectrum of ClO₂ in the gas phase.

### DETAILED DESCRIPTION OF THE INVENTION

The invention consists of a novel, automated system for upstream, in-line chemical disinfection of runoff water. The system features one or more of the following attributes. As used herein, the term “in-line” refers to being placed in contact to an open channel, at the entrance of a catchment basin, such as a storm drain collection point, a creek, a stream, a pipe or any other conduit or conveyance for water.

The system treats water either soon after it is collected and enters the drainage system, or further downstream where multiple flows of water are merged. Since the system can be made small and low powered, it has enhanced transportability that permits it to be deployed even in remote field sites and at relatively small collection sites if desired.

Efficiency is another feature of the system. The system can use disinfection chemicals that have an established track record in other, related industries (e.g., conventional wastewater treatment and drinking water treatment). Such chemicals provide for rapid disinfection (preferably within seconds of contact) and at high rates (about 50% and greater reduction in pathogen colony forming units, CFU's.)

The system can incorporate process control, chemical injection, and, where applicable, photochemical activation, which can be managed by a control system using a process model and inputs from sensors. The system can also carry out residue monitoring, e.g., overdosing of the added chemical(s) can be avoided by monitoring for residues downstream of a mixing chamber. The mixing chamber 6 can comprise a section of the system and/or a region of a conduit were mixing of the water to be treated and the chemical disinfectant takes place.

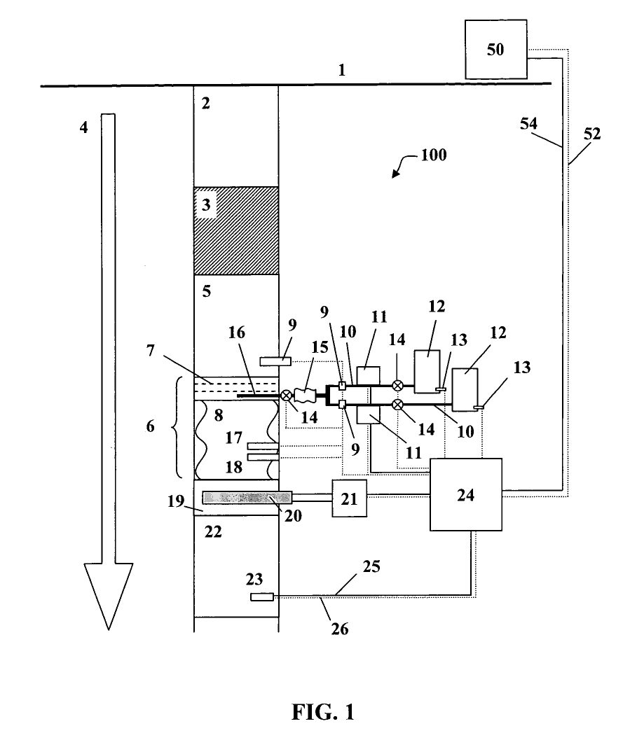

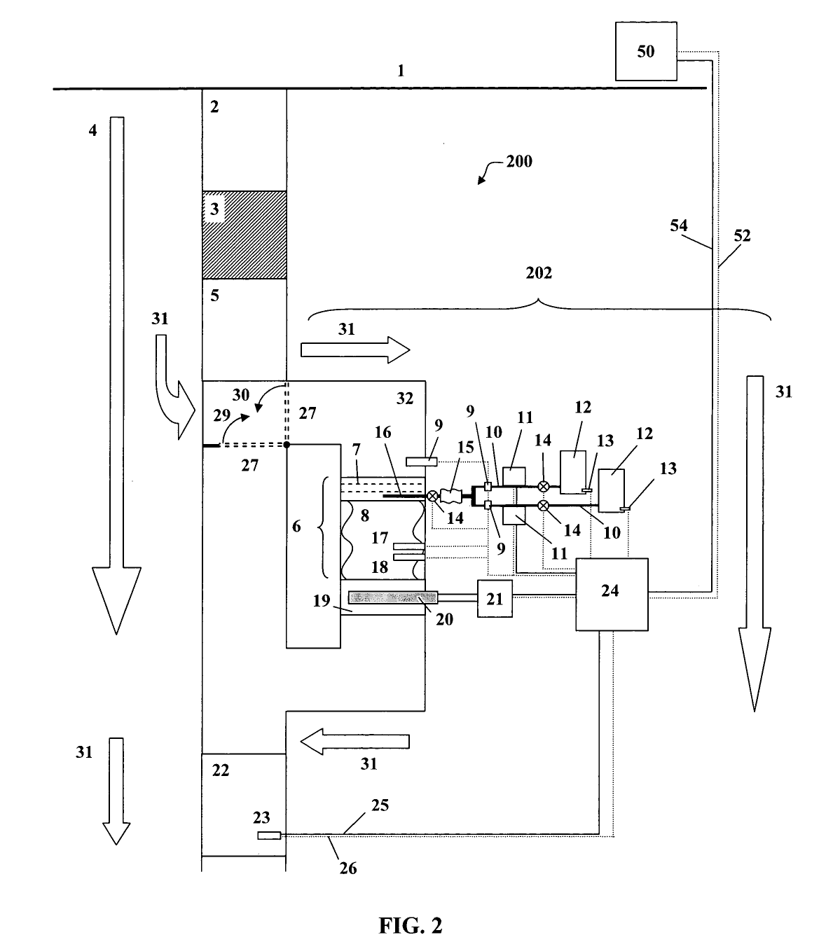

Two exemplary configurations of the system are shown schematically in FIGS. 1 and 2.

Referring to FIG. 1 there is shown a schematic view of an exemplary embodiment of an in-line configuration of the system 100 and referring to FIG. 2 there is shown a schematic view of an exemplary embodiment of a by-pass configuration 200. Runoff water from a catchment 1 is channeled into a conduit 2 and, subsequently, to an optional sediment, debris and/or hydrocarbon collection and filter system 3. The direction of water flow is shown by arrow 4. In the case of debris and/or hydrocarbon collection and filter systems installed directly to the catchment, conduit 2 can be omitted. The use of a debris and/or hydrocarbon collection and filter system 3 is not a prerequisite for the use of the disclosed disinfection system, but can be desirable as the removal of sediments and suspended particles may allow for better contact between the disinfection agent and the microorganisms and other pathogens.

Another conduit 5 channels the optionally filtered water flow to mixing chamber 6. The mixing chamber 6 can be directly in-line with a main water flow drainage line (as shown in FIG. 1), or in the by-pass configuration (as shown in FIG. 2.) In the by-pass configuration of FIG. 2, a mechanical baffle 27 is placed in an opened position 29 or a closed position 30 as a function of the water flow rate. For example, at heavy flow rates, the baffle 27 is moved to the closed position 30 to prevent water from entering the by-pass unit 202 along flow arrows 31. Under these conditions, the water flows as shown by arrows 4 and 40. In the direct in-line system of FIG. 1, at all flow rates the wastewater flows along arrow 4. Referring back to FIG. 2, at low flow rates, baffle 27 moved to its opened position 29, forces water flow into a by-pass unit 32, as shown by arrows 31. The baffle 27 can be activated either passively (i.e., by the force exerted by the water flow on the baffle arrangement) or actively (i.e., by a mechanical device such as a solenoid or motor). In use of the system, after long and particular heavy water flows, or in other cases where the water being monitored is relatively free from contaminants, the bypass unit 32 may be bypassed.

The water is thoroughly mixed in a mixing chamber 6 using a single, or a combination of, static device(s), such as grids 7 and helical fins 8. Any other known static (and/or even active) mixing devices can be used to ensure adequate mixing of the stormwater and the chemicals. The flow rate of the water entering the mixing chamber is measured by a flow meter 9. Chemical solutions contained in one or more storage containers 12 are metered through a line 10 and valves 14 by motive means such as pumps 11. The chemical solutions can also be moved out of the storage containers 12 by motive means such as pressure in the storage containers. Valves 14 provide a means of shutting off the flow of chemicals into the drainage lines and are an important safety feature. Level meters 13 can be provided to measure the amount of chemical solutions remaining in the storage containers 12. The chemical flows from the pumps 11 are monitored by flow sensor(s) 9 before they are mixed by in-line mixing tube 15 prior to being injected into the water flow via a probe 16. The in-line mixing tube 15 can contain helical fins to achieve preferably up to 100% mixing. Thorough mixing of chemical precursors (see Equations 2-10 below) generate certain active disinfectants (e.g., ClO₂). Sensors 17 and 18 measure such features as temperature, turbidity, pH, dissolved oxygen, and/or other physiochemical and/or biological properties of the stormwater. Sensors 17 and 18 can also constitute sensor arrays containing multiple instruments. One such sensor suite used in an embodiment of the invention can comprise a meteorological station 50 connected with a communication link 52 to the control unit 24 for measuring local weather conditions. An optional irradiation chamber 19 (which can be included depending on the chosen disinfection approach) is located immediately downstream of the mixing chamber 16. In one preferred embodiment of the disclosed invention, a UV source 20 can consists of a gas-filled lamp (e.g., mercury, xenon) surrounded by a quartz jacket. The UV source 20 exposes the water flow as shown in FIGS. 1 and 2. The UV beam is interfaced to the water flow using an appropriate optical system (e.g., beam expander followed by collimating optic, a bundle of optical fibers inserted perpendicular to the direction of water flow) as shown in FIGS. 1 and 2, or other known UV sources. The UV source(s) is powered by a power supply 21. An in situ sensor 23 measures any chemical residues (e.g., ClO₂, bromate) from the disinfection process. The nature of sensor 23 can span any continuous monitoring system for the analyte(s) of interest. In one preferred embodiment, sensor 23 consists of a miniature UV spectrometer (e.g., Czerny-Turner dispersive CCD array spectrometer, linear variable optical filter non-dispersive CCD array spectrometer) and a suitable UV-visible source interfaced to the water stream via a fiber optic cable. An in situ probe directly measures the UV-visible transmission of a small cross-section of the water column. Sensor 23 can be placed downstream of the mixing chamber and the optional irradiation chamber 19 in a section of wastewater conduit 22 sufficiently downstream to enable accurate characterization of the wastewater (e.g. after treatment.)

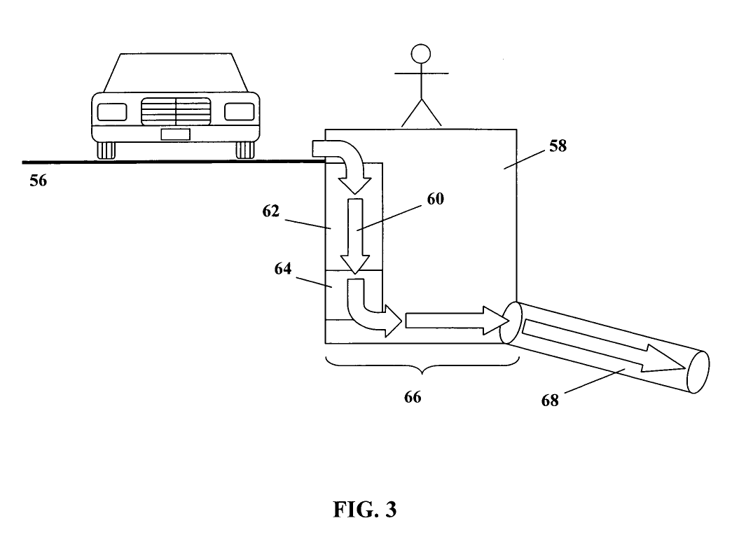

FIG. 3 is an exemplary embodiment of the invention wherein the disinfection system 64 is located in a catch basin 58 located on a street 56. In the exemplary embodiment, street runoff 60 enters the catch basin 58, preferably passes through a filtering medium in a catchment device 62, and is treated by the disinfection device 64 in a catch basin mixing region 66, after which it is discharged into a stormwater conduit 68.

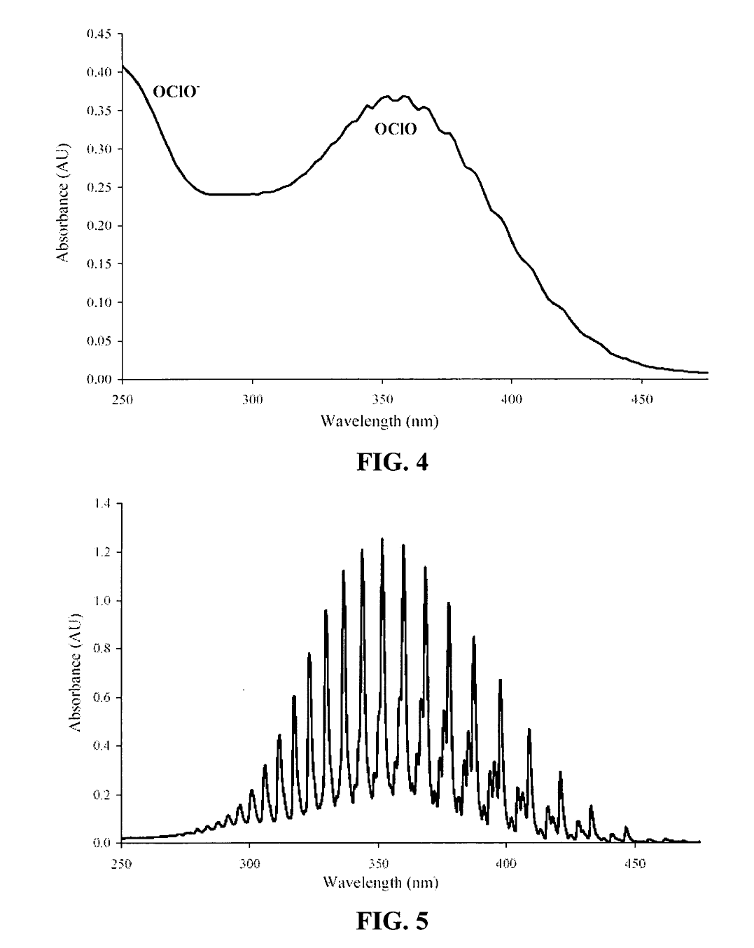

Turning to FIG. 4, the absorption at wavelengths typical of aqueous ClO₂, for example, is used to continuously monitor the concentration of this chemical using, for example, the Beer-Lambert law. FIG. 5 is a gas phase absorption spectrum Of ClO₂.

In an embodiment of the invention, the concentration of an indicator of pathogenic microorganisms, such as Escherichia coli, can be monitored upstream of mixing chamber 6 as well as downstream of an optional irradiation chamber 19. In a preferred embodiment of the invention, a continuous biological, bacterial sensor 23 can comprise an immunosensor. The biological sensor 23 can be used with or without the chemical sensor 9. A control system 24 reads the inputs from all peripheral sensors and controls the addition of chemicals to the water stream. The control system 24 can, for example, include a miniature PC using the PC-104 architecture. Custom analog and/or digital input-outputs, Ethernet, modem, and signal processing boards can be conveniently interconnected on the PC-104 stack. In another embodiment of the invention a custom board containing a microcontroller replaces the PC-104 CPU board. All components can be connected by power and signal lines 25 and 26, respectively. If desired, the system can be powered by solar cells or from an external power source.

The system of the invention is designed to permit telemetry (e.g., via RF modem and/or cellular technology) to a central management station. Alternatively or concurrently, the Ethernet and/or modem capabilities allow the system to be connected to the Internet or other computer networks. Remote access to the disinfection systems allows a wide range of features to be implemented, including: (1) Remote adjustment of dosage rates; (2) Dynamic transfer of data to the system (e.g., predicted storm event) to allow pre-administration of chemicals prior to the “first flush”; (3) Remote system diagnosis; and (4) Remote inventory control (e.g. of chemical solution levels in tanks 12.)

In one preferred embodiment of the disclosed invention, the chemical feedstock consists of reagents generating chlorine dioxide (ClO₂) made in situ in mixing tube 15 just before being injected into mixing chamber 6. Chlorine dioxide is unstable and, therefore, needs to be generated immediately before use from stable starting materials. The generation of ClO₂ is achieved using established procedures, including, but not limited to, any of the following:

(a) Oxidation of chlorite by persulfate, Eq. (2),

2NaClO₂+Na₂S₂O₈→2ClO₂+2Na₂SO₄ (2)

(b) Reaction of sodium hypochlorite and sodium chlorite, Eq. (3),

NaOCl+2NaClO₂+HCl—2ClO₂+3NaCl+H₂O (3)

(c) Acidification of chlorite, Eq. (4),

5ClO⁻₂+4H⁺→4ClO₂+2H₂O+Cl⁻ (4)

(d) Electrochemical oxidation of chlorite, Eq. (5),

ClO⁻₂→ClO₂+e⁻ (5)

(e) Reduction of chlorates by acidification in the presence of oxalic acid, Eq. (6),

2HClO₃+H₂C₂O₄→ClO₂+2CO₂+H₂O (6)

(f) ERCO R-2™ and ERCO R-3™ processes, Eq. (7), by the Sterling Pulp Chemicals, Ltd. of, Toronto, Ontario, Canada.

NaClO₃+NaCl+H₂SO₄→ClO₂+1/2Cl₂+Na₂SO₄+H₂O (7)

(g) ERCO R-5™ process, Eq. (8),

NaClO₃+2NaCl→ClO₂+1/2Cl₂+NaCl+H₂O (8)

(h) ERCO R-8™ and ERCO R-10™ processes, Eq. (9),

3NaClO₃+2H₂SO₄+0.85CH₃OH→3ClO₂+Na₃H(SO₄)₂+H₂O+0.05CH₃OH+0.6HCO₂H+0.2CO₂ (9)

(i) ERCO R-11™ process, Eq. (10),

NaClO₃+1/2H₂O₂+H₂SO₄→ClO₂+NaHSO₄+H₂O+1/2O₂ (10)

The use of ClO₂ as a disinfection agent has a number of well-known advantages, including: (a) Stored starting materials are usually of lower toxicity than the disinfection agent, ClO₂—this is a significant advantage over chlorine (Cl₂); (b) Ease of generation and application; (c) Automated controlled addition can be achieved easily and safely; (d) Broad spectrum of effectiveness against microorganisms (bacteria, yeasts, spores, viruses); (e) Strong algaecide effect of ClO₂ eliminates the use of organic biocides; (f) Long-term stable disinfection effect—microorganisms are not known to develop immunities; (g) Low pollution risk as ClO₂ is unstable and rapidly decomposes in the water stream. In addition and unlike Cl₂, ClO₂ suppresses the formation of toxic, carcinogenic volatile haloforms, non-volatile organic halogen compounds, and chlorophenols; (h) Destroys chloramines by oxidation—chloramines lead to irritations of the mucous membranes, especially those of the eyes; (j) Does not react with ammonia or ammonium ions; (k) Typically applied in lower doses than Cl₂; (l) Often disinfects faster than Cl₂; (m) Disinfection efficiency is independent of pH in the 6-10 range; (n) Low corrosivity to metals, unlike Cl₂; and (o) economical.

In another embodiment of the invention, a known peroxide, such as peracetic acid (CH₃COOOH) or a suitable peracetic acid precursor or aqueous hydrogen peroxide (H₂O₂), or suitable H₂O₂ precursors, is used in lieu of the materials for ClO₂ production. The mixed peroxide-water solution then is preferably photolyzed by UV source 20 in irradiation chamber 19. This process produces a potent biocide, hydroxyl radicals (OH⁻), as shown in Eq. (11):

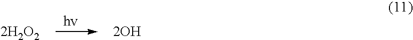

One advantage of using OH instead of ClO₂ for water disinfection is that the former will not lead to chlorinated residues. A disadvantage is the need for UV irradiation.

In yet another embodiment of the disclosed invention, an aqueous solution of a persulfate (S₂O₈²⁻) salt, such as sodium persulfate, is used in lieu of the materials for ClO₂ production. The mixed (S₂O₈²⁻)-water solution then is preferably photolyzed by UV source 20 in irradiation chamber 19. This process produces a potent biocide, sulfate radical anions (SO₄⁻), as shown in Eq. (12):

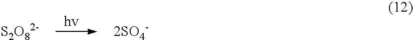

An advantage of using SO₄— instead ClO₂ for water disinfection is that the former will not lead to chlorinated residues; a disadvantage is the need for UV irradiation. A feed-back model reads the array of physical, chemical, and biological parameters measured by sensors 9, 17, 18, and/or 23 and uses this information to dose the chemical disinfectant. The model can be derived from laboratory and from field measurements (e.g., predominant pathogenic microorganisms at the site, chemical composition of a typical stormwater sample, soil composition) and field conditions (e.g., geographical location, meteorological patterns, nature of catchment) to efficiently disinfect water without leading to harmful, downstream chemical residues.

With the appropriate sensors in place, the model can optimize disinfection efficiency as a function of a wide range of variables, including: (a) Meteorological conditions offer important parameters for the model such as: time elapsed since last rainfall, severity of rainfall, ambient temperature. In certain cases, the model may initiate chemical administration based on measured rainfall, prior to receiving the first wave of water at mixing chamber 6, (b) Water flow rate is a key parameter since it largely dictates the concentration of microorganisms in the water. Levels will be highest in a slow-flowing “first flush” event, or during short rainfall-induced pulses. Levels will be lowest at high flow rates a certain time after the “first flush”. The model can log the flow rate as a function of time and use this historic data to determine disinfectant dosage rates; (c) The physiochemical and biological parameters monitored by sensor suite 17 and 18 partially will determine the target concentration of the disinfection agent; (d) Sensor(s) 23 will determine the efficiency of disinfection as well as any residual disinfection agent(s). This information can be used to control the addition of chemical feedstocks.

In an embodiment of the invention, the model can trigger routine disinfection cycles during dry periods. To achieve this, water may be injected into the system upstream of mixing chamber 6, and usually upstream of debris and hydrocarbon collection system 3.

The present invention covers the modifications and variations of this invention provided they come within the scope of the appended claims and their equivalents. In this context, equivalents mean each and every implementation for carrying out the functions recited in the claims, even those not explicitly described herein.

What is claimed is:

1. A wet and dry weather water disinfection system, comprising:
a disinfecting chemical dispenser;
a mixing chamber wherein a disinfection chemical from the disinfecting chemical dispenser is added to the water to be treated; and
a control unit that controls the addition of disinfection chemical to the water to be treated.

2. The wet and dry weather water disinfection system of claim 1, further comprising a sensor to measure the water's characteristics.

3. The wet and dry weather water disinfection system of claim 2, wherein the sensor to measure water characteristics is located upstream of the disinfecting chemical dispenser.

4. The wet and dry weather water disinfection system of claim 3, further comprising a sensor in the mixing chamber to measure characteristics of the water mixed with the disinfecting chemical.

5. The wet and dry weather water disinfection system of claim 3, further comprising a sensor downstream of the mixing chamber to measure the chemically treated water's characteristics.

6. The wet and dry weather water disinfection system of claim 1, wherein the control unit incorporates a feed-back protocol that incorporates an array of physical, chemical and/or biological parameters for efficiently disinfecting the water.

7. The wet and dry weather water disinfection system of claim 1, further comprising a power source selected from the group consisting of battery power, externally supplied power, and a solar power unit.

8. The wet and dry weather water disinfection system of claim 1, further comprising a communication unit that permits communication between the wet and dry weather water disinfection system and a distant management station.

9. The wet and dry weather water disinfection system of claim 8, wherein the communication unit comprises at least one of a wireless telemetry unit, and wired communication unit for connection to a computer network.

10. The wet and dry weather water disinfection system of claim 8, wherein the communication unit provides for at least one of remote adjustment of dosage rates, dynamic transfer of data to the system to allow pre-administration of chemicals prior to a first flush event, remote system diagnosis, and remote inventory control.

11. The wet and dry weather water disinfection system of claim 1, further comprising a flow meter to measure the flow rate of water through the system.

12. The wet and dry weather water disinfection system of claim 1, wherein sensor measures at least one of temperature, turbidity, pH, dissolved oxygen, bacterial count, and chemical residue level.

13. The wet and dry weather water disinfection system of claim 1, wherein the disinfecting chemical dispenser comprises a chemical storage container, a valve, a motive means to move the disinfecting chemical from the storage container to the mixing chamber, and a probe through which the disinfecting chemical is injected into the mixing chamber.

14. The wet and dry weather water disinfection system of claim 14, wherein the disinfecting chemical dispenser comprises plurality of chemical storage containers which store feedstocks of precursor chemicals to the disinfecting chemical.

15. The wet and dry weather water disinfection system of claim 1, further comprising a UV radiation source that illuminates the solution of wastewater and chemical downstream of the mixing chamber.

16. The wet and dry weather water disinfection system of claim 1, wherein the disinfecting chemical comprises chlorine dioxide.

17. The wet and dry weather water disinfection system of claim 1, wherein the disinfecting chemical comprises a solution of a peroxide or a peroxide precursor.

18. The wet and dry weather water disinfection system of claim 15, wherein the disinfecting chemical comprises a solution of a peroxide or a peroxide precursor, and the mixed-peroxide and water to be treated solution is then photolyzed by the UV radiation source.

19. The wet and dry weather water disinfection system of claim 1, wherein the disinfecting chemical comprises a solution of a persulfate (S₂O₈²⁻) salt.

20. The wet and dry weather water disinfection system of claim 15, wherein the disinfecting chemical comprises a solution of a persulfate (S₂O₈²⁻) salt, and the mixed (S₂O₈²⁻)-stormwater solution is then photolyzed by the UV radiation source.

21. The wet and dry weather water disinfection system of claim 1, wherein the disinfection system is locatable in-line at a storm drain collection location.

22. The wet and dry weather water disinfection system of claim 1, wherein the water disinfection system is provided as a bypass system, which further comprises a baffle to control the flow of water either directly through a water conduit or through the water disinfection system.

23. The wet and dry weather water disinfection system of claim 1, wherein the mixing chamber has static mixing parts to ensure thorough mixing of the water with the added disinfecting chemical.

24. The wet and dry weather water disinfection system of claim 1, further comprising a filtering system for capturing at least one of sediments, debris and hydrocarbons prior to treatment with the disinfecting chemical.

25. An automated system for chemical disinfection of wet and dry weather water, comprising:
a disinfecting chemical dispenser;
a mixing chamber wherein a disinfection chemical from the disinfecting chemical dispenser is added to water to be treated and the water and the disinfecting chemical mix;
a sensor to measure the water's characteristics; and
a control unit that controls the injection of disinfection chemical to the water.

26. The automated chemical disinfection system of claim 25, wherein the sensor to measure water characteristics is located upstream of the disinfecting chemical dispenser.

27. The automated chemical disinfection system of claim 25, further comprising a sensor in the mixing chamber to measure characteristics of the water mixed with the disinfecting chemical.

28. The automated chemical disinfection system of claim 25, further comprising a sensor downstream of the mixing chamber to measure the chemically treated water's characteristics.

29. The automated chemical disinfection system of claim 22, wherein the control unit incorporates a feed-back protocol that incorporates an array of physical, chemical and/or biological parameters for efficiently disinfecting the water.

30. The automated chemical disinfection system of claim 25, further comprising a communication unit that permits communication between the water disinfection system and a distant management station.

31. The automated chemical disinfection system of claim 25, wherein the communication unit provides for at least one of remote adjustment of dosage rates, dynamic transfer of data to the system to allow pre-administration of chemicals prior to the a first flush event, remote system diagnosis, and remote inventory control.

32. The automated chemical disinfection system of claim 25, further comprising a flow meter to measure the flow rate of water through the system.

33. The automated chemical disinfection system of claim 25, wherein sensor measures at least one of temperature, turbidity, pH, dissolved oxygen, bacterial count, and chemical residues.

34. The automated chemical disinfection system of claim 25, wherein the disinfecting chemical dispenser comprises a chemical storage container, a valve, a motive means to move the disinfecting chemical from the storage container to the mixing chamber, and a probe through which the disinfecting chemical is injected into the mixing chamber.

35. The automated chemical disinfection system of claim 25, further comprising a UV radiation source that illuminates the solution of water and chemical downstream of the mixing chamber.

36. The automated chemical disinfection system of claim 25, wherein the disinfecting chemical comprises chlorine dioxide.

37. The automated chemical disinfection system of claim 35, wherein the disinfecting chemical comprises a solution of a peroxide or a peroxide precursor, and the mixed peroxide and water to be treated solution is then photolyzed by the UV radiation source.

38. The automated chemical disinfection system of claim 25, wherein the disinfecting chemical comprises a solution of a peroxide or a peroxide precursor.

39. The automated chemical disinfection system of claim 35, wherein the disinfecting chemical comprises a solution of a persulfate (S₂O₈²⁻) salt, and the mixed (S₂O₈²⁻)-water to be treated solution is then photolyzed by the UV radiation source.

40. The automated chemical disinfection system of claim 25, wherein the disinfecting chemical comprises a solution of a persulfate (S₂O₈²⁻) salt.

41. The automated chemical disinfection system of claim 25, further comprising a filtering system for capturing at least one of sediments, debris and hydrocarbons prior to treatment with the disinfecting chemical.

42. An automated system for chemical disinfection of water, comprising:
a disinfecting chemical dispenser;
a mixing chamber wherein a disinfection chemical from the disinfecting chemical dispenser is added to water and the water and the disinfecting chemical mix;
sensors to measure the water's characteristics comprising at least one sensor located upstream of the disinfecting chemical dispenser, at least one sensor in the mixing chamber, and at least one sensor downstream of the mixing chamber to measure the chemically treated water's characteristics; and
a control unit that controls the injection of disinfection chemical to the water, wherein the control unit incorporates a feed-back protocol that incorporates an array of physical, chemical and/or biological parameters for efficiently disinfecting the water.

43. The automated system for chemical disinfection of water of claim 42, further comprising a communication unit that permits communication between the water disinfection system and a distant management station.

44. The automated system for chemical disinfection of water of claim 42, wherein the communication unit provides for at least one of remote adjustment of dosage rates, dynamic transfer of data to the system to allow pre-administration of chemicals prior to the a first flush event, remote system diagnosis, and remote inventory control.

45. The automated system for chemical disinfection of water of claim 42, further comprising a flow meter to measure the flow rate of stormwater through the system.

46. The automated system for chemical disinfection of water of claim 42, wherein sensor measures at least one of temperature, turbidity, pH, dissolved oxygen, bacterial count, and chemical residues.

47. The automated system for chemical disinfection of water of claim 42, wherein the disinfecting chemical dispenser comprises a chemical storage container, a valve, a motive means to move the disinfecting chemical from the storage container to the mixing chamber, and a probe through which the disinfecting chemical is injected into the mixing chamber.

48. The automated system for chemical disinfection of water of claim 42, further comprising a UV radiation source that illuminates the solution of wastewater and chemical downstream of the mixing chamber.

49. The automated system for chemical disinfection of water of claim 42, wherein the disinfecting chemical comprises chlorine dioxide, and the chemical dioxide is generated in the disinfection system prior to use.

50. The automated system for chemical disinfection of water of claim 48, wherein the disinfecting chemical comprises a solution of a peroxide or a peroxide precursor, and the mixed H₂O₂-stormwater solution is then photolyzed by the UV radiation source.

51. The automated system for chemical disinfection of water of claim 42, wherein the disinfecting chemical comprises a solution of a peroxide or a peroxide precursor.

52. The automated system for chemical disinfection of water of claim 48, wherein the disinfecting chemical comprises a solution of a persulfate (S₂O₈²⁻) salt, and the mixed (S₂O₈²⁻)-water solution is then photolyzed by the UV radiation source.

53. The automated system for chemical disinfection of water of claim 42, wherein the disinfecting chemical comprises a solution of a persulfate (S₂O₈²⁻) salt.
